(19) United States
(12) Patent Application Publication
(10) Pub. No.: US 2020/0206993 A1
(43) Pub. Date: Jul. 2, 2020

(54) INJECTION-MOLDING METHOD AND LIQUID CONTAINER FOR A MOTOR VEHICLE

(71) Applicant: KAUTEX TEXTRON GMBH & CO. KG, Bonn (DE)

(72) Inventors: Roman BOUFFIER, Koenigswinter (DE); Hartmut WOLF, Koenigswinter (DE); Christian KOPIEC, Troisdorf (DE); Klaus GEBERT, Willich (DE); Sebastian Stefan ROSENSTRAETER, Koeln (DE); Fabian SIGGIA, Koeln (DE); Markus HUETZEN, Sankt Augustin (DE)

(21) Appl. No.: 16/643,188

(22) PCT Filed: Aug. 24, 2018
(86) PCT No.: PCT/EP2018/072927

§ 371 Date: Feb. 28, 2020

(30) Foreign Application Priority Data
Aug. 28, 2017 (DE) 10 2017 119 706.0

(51) Int. Cl. B29C 45/14

(52) U.S. Cl. CPC B29C 45/14377; B29C 45/14811; B29L 2031/7172; B29C 2045/14663; B29C 45/14655

(57) ABSTRACT

An injection-molding method for manufacturing a half-shell of a liquid container for a motor vehicle, comprising the following steps: providing a barrier film in a cavity of an injection-molding tool, the cavity being provided for the purpose of shaping the half-shell; providing a barrier sleeve in the cavity; injecting plasticized injection-molding material into the cavity, wherein plasticized injection-molding material is sprayed onto the barrier film and/or the barrier film is back-injected with plasticized injection-molding material; and wherein the barrier sleeve is back-injected with plasticized injection-molding material and/or overmolded with plasticized injection-molding material to form a connection element of the half-shell.

### FIELD

The present invention relates to an injection-molding method for manufacturing a half-shell of a liquid container for a motor vehicle, and to a liquid container for a motor vehicle.

### BACKGROUND

A large number of operating fluids are carried in modern motor vehicles, each of which is accommodated in a liquid container for a motor vehicle. For example, plastic fuel tanks are used to store fuel for an internal combustion engine.

Such plastic fuel tanks should ideally be light, crash-proof, and low in emissions. With regard to emissions, the stricter legal limit values for the maximum permissible fuel evaporation emissions from hydrocarbons into the environment must be observed. This requires, in particular, that fuel leaks be avoided under all operating conditions, such as during fueling, including refueling ventilation, during operational ventilation, i.e., fuel outgassing when the temperature of a tank system rises, and that the diffusion of the hydrocarbons through the tank wall be minimized.

In order to keep the diffusion through the container wall low, fuel containers often have a multilayer wall structure that includes a diffusion barrier, adhesion promoter, and cover layers. A barrier layer is usually bordered on two sides by two adhesive layers, which, in turn, are each covered by a cover layer. This results in a five-layer wall structure, for example, with a barrier layer made of EVOH, two adhesion promoter layers made of LDPE, and two cover layers made of HDPE.

If such a liquid container is produced with a barrier layer using the injection-molding method, the barrier layer is broken through in the vicinity of injection-molded connection elements such as a filler neck, a breather pipe, or the like. By breaking through the barrier layer, permeation paths are formed in the vicinity of such connection elements along which increased emission occurs during operation of hydrocarbons that diffuse out.

### SUMMARY

Against this background, the invention is based on the technical problem of specifying an injection-molding method for manufacturing a half-shell of a liquid container for a motor vehicle and a liquid container for a motor vehicle that do not have the disadvantages mentioned above or at least to a lesser extent and, in particular, enable reduced diffusion-related emissions to be achieved.

According to a first aspect, the invention relates to an injection-molding method for manufacturing a half-shell of a liquid container for a motor vehicle, with the method steps:
providing a barrier film in a cavity of an injection-molding tool, the cavity being provided for the purpose of shaping the half-shell;
providing a barrier sleeve in the cavity;
injecting plasticized injection-molding material into the cavity,
   with plasticized injection-molding material being sprayed onto the barrier film and/or the barrier film being back-injected with plasticized injection-molding material; and
   with the barrier sleeve being back-injected with plasticized injection-molding material and/or overmolded with plasticized injection-molding material to form a connection element, in particular a connecting piece, of the half-shell.

Diffusion-related emissions can be reduced through incorporation of the barrier sleeve in the region of the connection element.

The connection element can be a adapter. The adapter can be designed to connect a hose or a pipe. The adapter can have a circumferential chamfer or a circumferential web as a holding element for fastening a hose. The adapter can have the circumferential profile of a fir tree for holding a hose. The adapter can have a circular bulge for holding a hose. Alternatively or in addition, at least one connection element can be provided that is intended for the passage of electrical lines.

According to another embodiment, the injection-molding method is characterized by the provision of a barrier sleeve in the cavity, with the method steps: inserting the barrier sleeve into a recess in order to shape the connection element; and/or pushing the barrier sleeve onto a mandrel of the injection-molding tool.

The barrier sleeve can thus be held in a form-fitting manner in an injection-molding tool, it being possible for a mandrel or a recess to be provided for the purpose of holding the barrier sleeve on a mold half of an injection-molding tool. In this way, the barrier sleeve can be reliably and accurately positioned in an injection-molding tool. The barrier sleeve can be held on the injection-molding tool by means of a vacuum or electrostatically.

According to another embodiment, the injection-molding method is characterized by the provision of the barrier film and the barrier sleeve in such a manner that a longitudinal axis of a through hole of the barrier sleeve is oriented transverse to an outer or inner surface of the barrier film and/or that the barrier film rests against the barrier sleeve.

In particular, the longitudinal axis of the through hole of the barrier sleeve can be oriented perpendicular to an outer surface or inner surface of the barrier film.

The barrier film can rest against the barrier sleeve in such a manner that the barrier film lies in a flush or overlapping manner against the barrier sleeve, particularly without a gap. The barrier sleeve thus complements the barrier effect of the barrier film in the vicinity of the connection element.

According to another embodiment, the injection-molding method is characterized by the provision of the barrier film and the barrier sleeve in such a manner that a through hole of the barrier film is flush with a through hole of the barrier sleeve at least in some portions and/or that a through hole of the barrier film and a through hole of the barrier sleeve are arranged so as to be coaxial.

For example, a barrier film can be provided that is perforated at one or more points—i.e., that has one or more through holes. A barrier sleeve of a connection element can be associated with each through hole of the barrier film in order to achieve a reduction in the diffusion-related emissions of a respective connection element.

According to another embodiment, the injection-molding method is characterized by the provision of the barrier film and the barrier sleeve in such a manner that the barrier sleeve is seated at least partially in a through hole of the barrier film. The barrier sleeve can be completely enclosed peripherally by the barrier film in the region of a partial length. The barrier film can bear against an outer lateral surface of the barrier sleeve, particularly without a gap.

According to another embodiment of the injection-molding method, the barrier sleeve and the barrier film are integrally connected. The integral connection can occur, for example, during the injection-molding method as a result of a pressure and a rise in temperature resulting from the injection of the plasticized injection-molding material. Alternatively, a provision can be made that the barrier sleeve has been integrally connected to the barrier film prior to injection of plasticized injection-molding material into the cavity.

The barrier sleeve and the barrier film can be integrally connected to one another at least in some portions in the region of an overlap. In particular, the barrier sleeve and the barrier film can be welded to one another or glued to one another at least in some portions. This enables the barrier effect to be improved in the region of a seam between the barrier film and the barrier sleeve.

Alternatively or in addition, the injection-molding material can be integrally connected to the barrier sleeve and/or the barrier film.

The barrier sleeve and the barrier film can be integrally connected to one another and also integrally connected to the injection-molding material. The connections can be established in a substantially simultaneous manner through the introduction of the plasticized injection-molding material into the injection-molding tool and the associated application of pressure and inputting of heat.

A provision can be made that the barrier sleeve is connected—particularly glued or welded—to the barrier film before it is introduced into an injection-molding tool.

According to a second aspect, the invention relates to a liquid container for a motor vehicle, with two interconnected half-shells that delimit a storage volume for holding a liquid, at least one of the half-shells having a barrier film as a diffusion barrier and a connection element, particularly a connecting piece, for connecting a hose or pipe, and at least one barrier sleeve being associated with the connection element that forms a diffusion barrier in the region of the connection element.

Diffusion-related emissions can be reduced through incorporation of the barrier sleeve in the region of the connection element. The barrier sleeve can be an integral part of a container wall of the half-shell and can, in particular, be integrally connected to a carrier material of the half-shell.

The barrier sleeve and/or the barrier film can be connected in similar fashion to a material of the half-shell. For example, the barrier sleeve and/or the barrier film can have cover layers made of HDPE that enclose a barrier layer, a cover layer being integrally connected to a carrier material of the half-shell that is made of HDPE.

Depending on the wall thickness and material, the barrier sleeve can be flexible or limp or have a stiff structure.

The barrier sleeve can be an inlay that is provided for insertion into a recess in an injection mold or for pushing onto a mandrel of an injection mold.

In particular, at least one half-shell can have been produced using a method according to the invention as described above.

The connection element can be a adapter. The adapter can be designed to connect a hose or a pipe. The adapter can have a circumferential chamfer or a circumferential web as a holding element for fastening a hose. The adapter can have the circumferential profile of a fir tree for holding a hose. The adapter can have a circular bulge for holding a hose or pipe. Alternatively or in addition, at least one connection element can be provided that is intended for the passage of electrical lines.

According to another embodiment of the liquid container, a provision is made that a longitudinal axis of a through hole of the sleeve is oriented transverse to an outer surface or inner surface of the barrier film.

In particular, the longitudinal axis of the through hole of the barrier sleeve can be oriented perpendicular to an outer surface or inner surface of the barrier film.

The barrier film can rest against the barrier sleeve in such a manner that the barrier film lies flush against the barrier sleeve, particularly without a gap. The barrier sleeve thus complements the barrier effect of the barrier film in the region of the connection element.

According to another embodiment of the liquid container, a provision is made that a through hole of the barrier film is arranged so as to be flush with a through hole of the barrier sleeve at least in some portions. Alternatively or in addition, a through hole of the barrier film and a through hole of the barrier sleeve can be arranged coaxially. Alternatively or in addition, the barrier sleeve can be seated in a through hole of the barrier film at least in some portions.

The barrier sleeve can be completely enclosed peripherally by the barrier film in the region of a partial length. The barrier film can bear against an outer lateral surface of the barrier sleeve, particularly without a gap.

The barrier sleeve and the barrier film can be integrally connected to one another at least in some portions. In particular, the barrier sleeve and the barrier film can be welded to one another or glued to one another at least in some portions. This enables the barrier effect to be improved in the region of a seam between the barrier film and the barrier sleeve.

According to another embodiment of the liquid container, a provision is made that the barrier film and/or the barrier sleeve is a monolayer, i.e., composed of a single layer. Alternatively or in addition, the barrier film and/or the barrier sleeve can be multilayered. Alternatively or in addition, the barrier film can be perforated.

The barrier film and/or the barrier sleeve can, for example, have a barrier layer made of EVOH (ethylene vinyl alcohol copolymer), two adhesion promoter layers made of LDPE (low-density polyethylene), and two cover layers made of HDPE (high-density polyethylene).

The injection-molding material can form a single-layer or multilayer carrier layer, which can have or consist of one or more of the following materials: Elastomer, thermoplastic elastomer, HDPE (high-density polyethylene), fiber-reinforced polyamide, PA (polyamide), partially aromatic polyamide, impact-resistant polyamide.

The single-layer or multilayer barrier layer can have or consist of one or more of the following materials: EVOH (ethylene vinyl alcohol copolymer), LDPE (low-density polyethylene), PEEK (polyether ether ketone), PA (polyamide), partially aromatic polyamide, HDPE (high-density polyethylene), fluoropolymer. For example, the barrier layer can be constructed in three layers from PA and EVOH, with a central EVOH layer being covered or bordered on two sides by PA cover layers. A six-layer wall structure, for example, or a five-layer structure made of HDPE, LDPE and EVOH can also be provided, in which case a central layer made of EVOH is covered on both sides by an LDPE layer, and the LDPE layers, in turn, are covered by HDPE layers.

For example, a barrier film can be provided that is perforated at one or more points—i.e., that has one or more through holes. A barrier sleeve of a connection element can be associated with each through hole of the barrier film in order to achieve a reduction in the diffusion-related emissions of a respective connection element.

According to another embodiment of the liquid container, a provision is made that a through hole of the connection element has a curved shape or has a bend, the connection element particularly forming a 45° connection, a 60° connection, or a 90° connection. The barrier sleeve can be adapted to the shape of the connection in order to provide a reliable barrier effect. A provision can be made for a connection with an inclination between 0° and 90°, it being possible for the inclination to be curved gradually as a freeform surface without forming a jump or bend.

According to another embodiment of the liquid container, a provision is made that the barrier film and the barrier sleeve are arranged so as to overlap at least in some portions, the barrier sleeve and/or the barrier film in particular having a flange or funnel shape at least in some portions. The overlap can reduce the emissions caused by diffusion in the region of a transition or a seam between the barrier film and the barrier sleeve.

According to another embodiment of the liquid container, a provision is made that the barrier film and the barrier sleeve are integrally connected to one another.

The barrier sleeve and the barrier film can be integrally connected to one another, particularly welded or glued to one another, for example in the region of an overlap.

Alternatively or in addition, the barrier sleeve and/or the barrier film can be connected integrally to an injection-molding material of the half-shell. Particularly, the injection-molding material can be a structuring carrier material to which the barrier film and/or the barrier sleeve are integrally connected. The barrier sleeve and/or the barrier film can thus be reliably incorporated into the liquid container so as to not be detachable in a destruction-free manner.

The barrier film and/or the barrier sleeve can have a wall thickness in a range from 100 μm to 1000 μm.

The half-shells of the liquid container can be integrally connected to one another, particularly welded to one another, along adjacent edges. A provision can be made that both half-shells have a barrier film with at least one barrier sleeve. A provision can be made that both half-shells have a barrier film but that only one half-shell has one or more connection elements with respectively associated barrier sleeves, while the other half-shell has no connection elements.

The barrier sleeve can be produced in one or more layers through extrusion of a hose material. This results in a seamless wall on the periphery with homogeneous component properties in terms of strength and barrier effect, for example. In order to achieve a multilayer structure, folded tubular films can be made available as raw material.

The barrier sleeve can be made from a single- or multilayer tape, film, or plate material that has been bent in the form of a sleeve and has been welded longitudinally along an abutting edge. In this case, the sleeve has a longitudinal seam.

A provision can be made that the ratio of a width or wall thickness b1 of the connection element in the region of a permeation path to a length L1 of the permeation path is less than or equal to 0.5 (b1/1L1<0.5).

### BRIEF DESCRIPTION OF THE DRAWINGS

In the following, the invention is described in further detail with reference to a drawing that illustrates exemplary embodiments:

FIG. 1 shows a cross section of a connection element of a liquid container according to the prior art;

FIG. 2 shows another cross section of a connection element of a liquid container according to the prior art;

FIG. 3 shows a cross section of a connection element of a liquid container according to the invention;

FIG. 4 shows a cross section of a liquid container according to the invention;

FIG. 5 shows a barrier sleeve and a barrier film before injection molding;

FIG. 6 shows the barrier sleeve and the barrier film from FIG. 5 after the injection molding;

FIG. 7-FIG. 14 show additional alternative cross-sectional shapes of a connection element of a liquid container according to the invention; and

FIG. 15 shows a workflow of an injection-molding method according to the invention.

### DETAILED DESCRIPTION

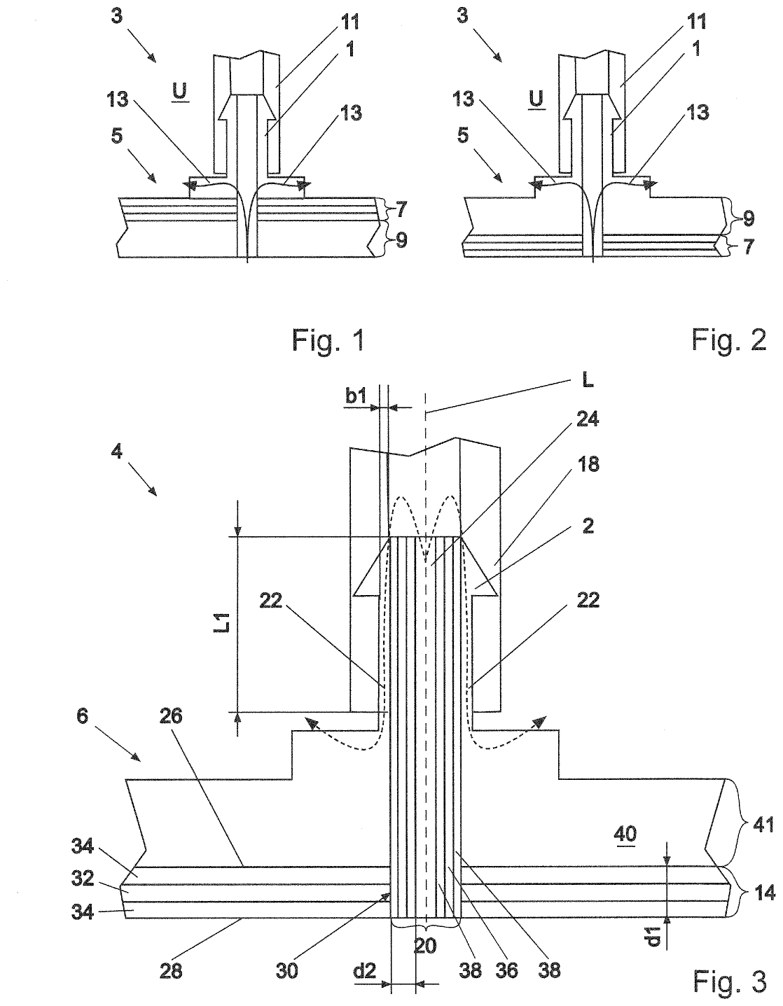

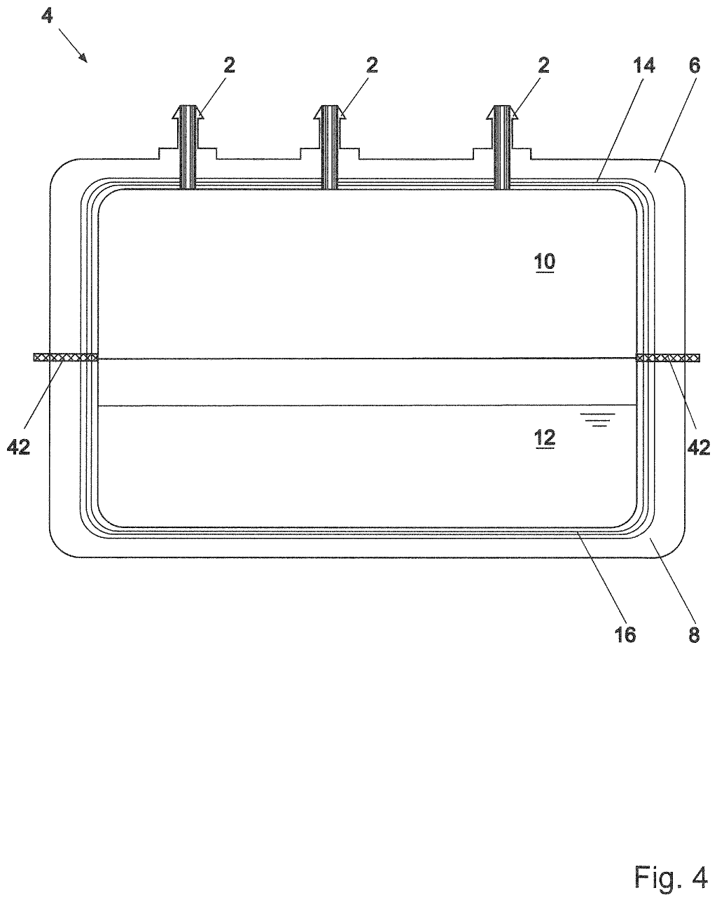

FIGS. 1 and 2 each show a cross section of a connection element 1 of a liquid container 3 according to the prior art. Only a portion of a wall 5 of the liquid container 3 is shown. The wall 3 of the liquid container 3 has a barrier layer 7 and a carrier layer 9. The connection element 1 is arranged on a side of the barrier layer 7 that faces away from the carrier layer 9 (variant according to FIG. 1) or is seated on the carrier layer 9 and the barrier layer is on the inside (variant according to FIG. 2). A hose 11 is pushed onto the connection element 1 and is part of a venting of the liquid container 3, for example.

If fuel is stored in the liquid container 3, there are increased diffusion-related fuel emissions along permeation paths 13. Fuel can diffuse out via the permeation paths 13, since plastic of the support layer 9 or the nozzle 1 is not confined from the surroundings U by the barrier layer 7 along these paths. As a result, hydrocarbon diffusion that is not limited by the barrier layer 7 occurs along the permeation paths 13 via the plastic of the carrier layer 9 and/or of the connection element 1, for example. The greater the number of connection elements 1 provided on a liquid container 3, the greater the fuel leaks due to diffusion-related hydrocarbon emissions or leakage into an environment U.

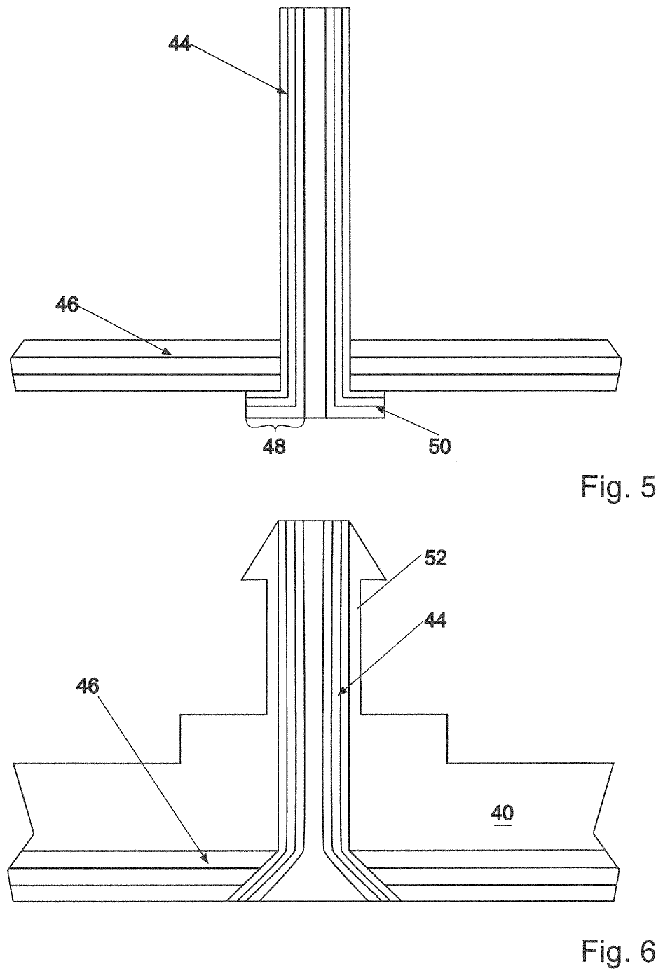

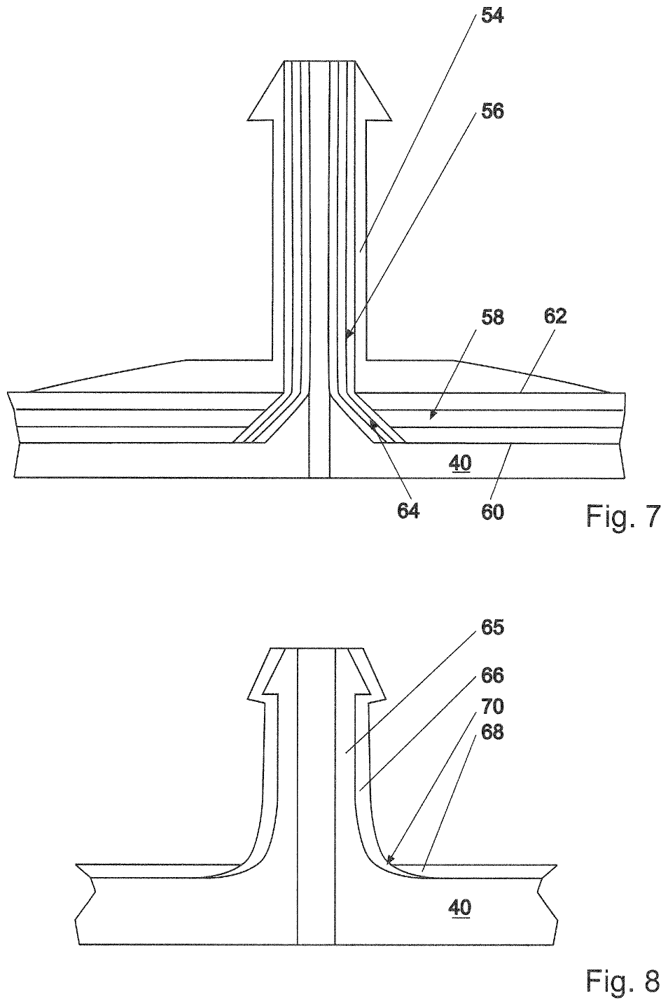

FIG. 3 shows a cross section of a connection element 2 of a liquid container 4 according to the invention (FIG. 4). In the present case, the liquid container 4 is a fuel container 4 for a motor vehicle.

The liquid container 4 has two interconnected half-shells 6, 8. The half-shells 6, 8 define a storage volume 10 for receiving a liquid 12. Here, the liquid 12 is fuel 12 for an internal combustion engine of a motor vehicle. The half-shells 6, 8 each have a multilayer barrier film 14, 16 as a diffusion barrier.

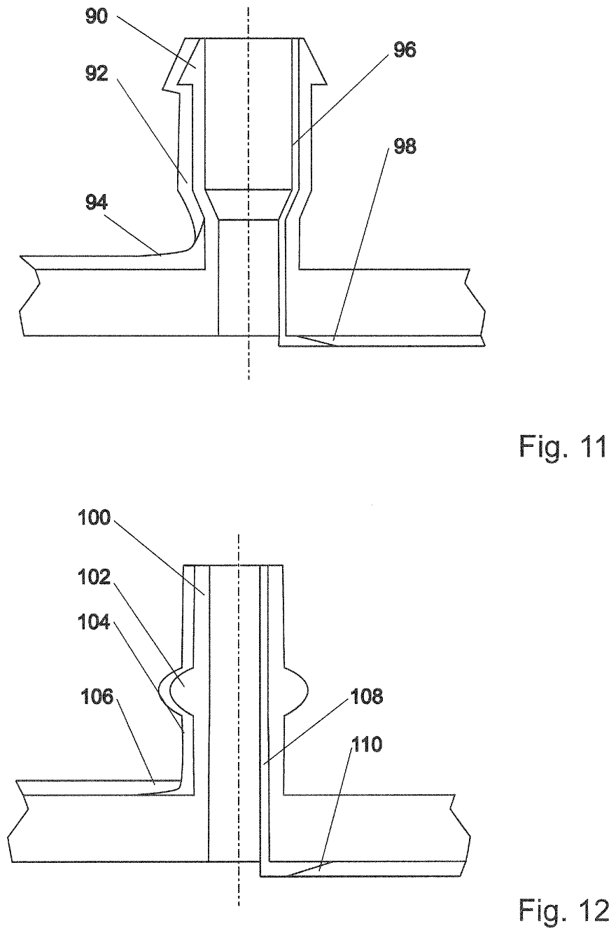

In the present case, the half-shell 6 has three connection elements 2. It will readily be understood that the arrangement, number, and geometry of connection elements that are provided on the half-shells 6, 8 can be varied in accordance with an alternative exemplary embodiment. For instance, as an alternative or in addition to the arrangement shown in FIG. 4, additional connection elements can be provided on a half-shell 6, 8 as shown in FIGS. 6 to 14, for example.

In the present case, the connection elements 2 are connecting pieces 2 that are set up for connecting a hose 18, as exemplarily illustrated in FIG. 3.

As can be seen in FIG. 3, a multilayer barrier sleeve 20 is associated with the connection element 2. Here, the barrier sleeve 20 forms a diffusion barrier in the region of the connection element 2. It is true that diffusion-related fuel emissions cannot be completely prevented by the barrier sleeve 20, as is indicated by the permeation paths 22. In the present example, however, by using the barrier sleeve 20, the free cross section along a permeation path 22 is reduced in comparison to the prior art according to FIGS. 1 and 2, and the diffusion path is also lengthened in comparison to the prior art. This enables the diffusion-related fuel emissions to be reduced substantially.

The barrier sleeve 20 has a longitudinal axis L along which a through hole 24 extends, the through hole 24 being oriented transverse, in this case perpendicular, to an outer surface 26 and an inner surface 28 of the barrier film 14. The barrier sleeve 20 is seated in a through hole 30 of the barrier film 14, and the through hole 30 also extends along the longitudinal axis L and is thus arranged coaxially with the barrier sleeve 20.

The barrier film 14 and the barrier sleeve 20 have a multilayer construction in the present case. The barrier film 14 has a barrier layer 32 that is enclosed on two sides by cover layers 34. The barrier sleeve 20 has a barrier layer 36 that is enclosed on two sides by cover layers 38.

The barrier film 14 and the barrier sleeve 20 are integrally connected to one another—in the present case welded to one another. In the present case, the barrier sleeve 20 and the barrier film 14 are also integrally connected to an injection-molding material 40 of a structuring carrier layer 41 of the half-shell 6. The injection-molding material 40 is a thermoplastic—HDPE in the present case. The cover layers 34, 36 are also HDPE, which makes same-type welding possible.

In the present case, the barrier film 14 has a wall thickness d1 of approximately 700 μm. In the present case, the barrier sleeve 20 has a wall thickness d2 of approximately 500 μm.

According to alternative embodiments, a provision can be made that the barrier sleeve 20 and/or the barrier film 14 are embodied as monolayers, meaning that they are composed of a single layer. In this case, the monolayer is both used for the integral connection of the barrier layer to the carrier material 40 and also has the function of a diffusion barrier for the stored fuel 12, particularly for hydrocarbons.

The ratio of a width b1 or wall thickness b1 of the connection element 2 in the region of a permeation path 22 to a length L1 of the permeation path is less than 0.5 in the present case (b1/L1<0.5).

As can be seen from FIG. 4, the two half-shells 6, 8 of the liquid container 4 are welded together in the regions 42.

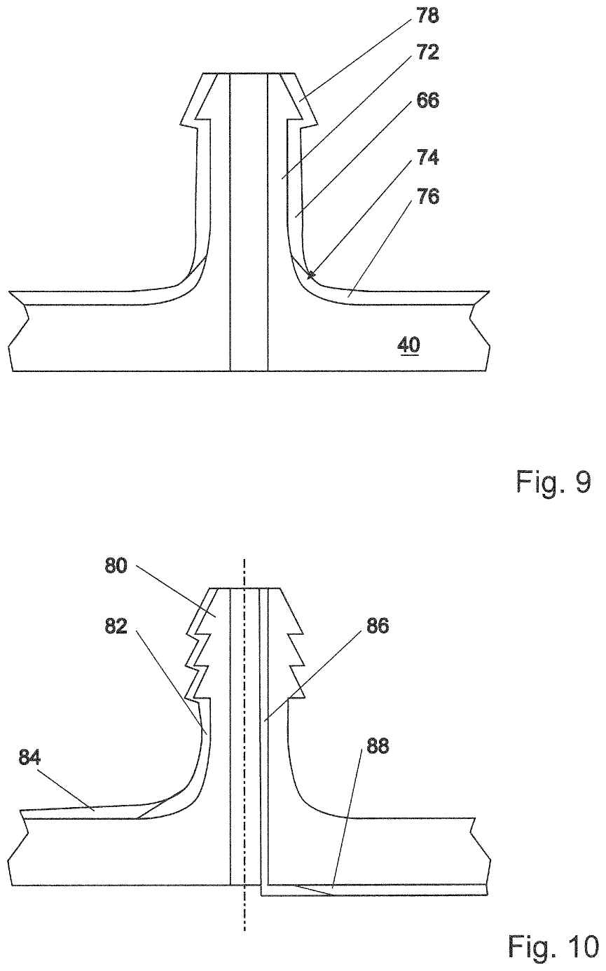

FIG. 5 shows a multilayer barrier sleeve 44 and a multilayer barrier film 46 before the injection or back-injection with carrier material 40. The barrier sleeve 44 and the barrier film 46 are arranged so as to overlap in a region 48. In the present case, the barrier sleeve 44 has a circular collar 50.

By injecting injection-molding material 40 into an injection mold (not shown), the barrier sleeve 44 and the barrier layer 46 are welded to one another in an overlapping manner as a result of the pressure and temperature input, as can be seen in FIG. 6. Moreover, an integral connecting or welding of the barrier sleeve 44 and the barrier layer 46 to the carrier material 40 also occurs.

The connection element 52 formed in this way thus has an inner barrier sleeve 44, the barrier film 46 also being arranged on the inside, i.e., so as to face toward a fuel to be stored.

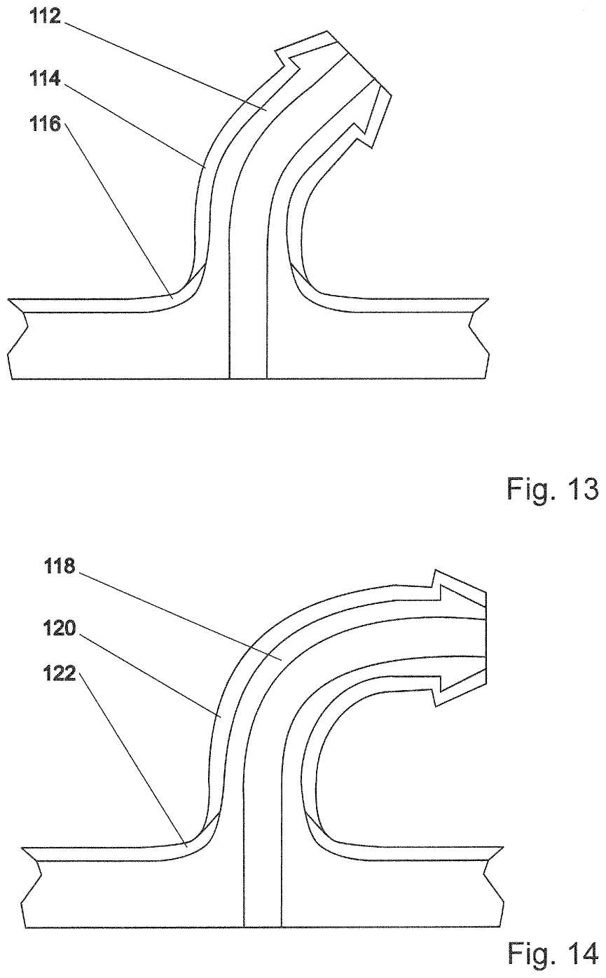

FIG. 7 shows another variant of a connection element 54 with an inner barrier sleeve 56. Compared to the example of FIG. 6, however, one barrier film 58 is arranged on the outside of a half-shell of a liquid container in this case—that is on a side of the half-shell facing away from the fuel to be stored.

The barrier film 58 is thus integrally connected to the carrier material 40 in the region of an inner side 60, while the connection element 54 is injection-molded locally on a side 62 facing away from the side 60. Like in the example of FIG. 6 as well, the example according to FIG. 7 has a collar or a flange 64 in the vicinity of which the barrier film 58 and the barrier sleeve 56 are arranged so as to overlap and are integrally connected to one another.

FIG. 8 shows another alternative of a connection element 65 in which a barrier sleeve 66 and also a barrier film 68 are each arranged on the outside, i.e., in the region of an outer side of a half-shell of the liquid container facing away from a storage volume of a liquid container.

In the present case, the barrier sleeve 66 has already been adapted to the resulting contour of the connection element 65 before the injection molding of the carrier material 40 and also has a flange 70 before the injection molding, in the vicinity of which the barrier sleeve 66 is integrally connected to the barrier film 68 as a result of the process of the injection molding of the initially plasticized carrier material 40. The barrier sleeve 66 and/or the barrier film 68 can be embodied as a monolayer or in multiple layers.

FIG. 9 shows another variant of a connection element 72 in which a flange 74 is provided on a barrier film 76. The barrier film 76 is thus already perforated with the carrier material 40 before the back-injection and has the flange 74 in order to form an overlap with a sleeve 78 that is provided in an injection-molding tool before the injection-molding process.

Depending on the hose, pipe, or cable to be connected, connection elements can have different types of profiles, as will be explained further below with reference to FIGS. 10-14. A variant is shown in FIGS. 10-14 on the left side of the dashed line in which the barrier layer and barrier sleeve are arranged on the outside, while a variant is shown on the right side of the dashed line for the illustrated profile of the connection element with barrier film and barrier sleeve on the inside.

FIG. 10 shows a connection element 80 having a fir tree profile. As shown exemplarily on the left side, a barrier sleeve 82 and a barrier film 84 can be arranged on the outside. In the present case, the barrier sleeve has already been adapted to the fir tree profile before injection molding. According to alternative exemplary embodiments, however, a provision can be made for a substantially circular cylindrical barrier sleeve that is formed into the fir tree profile exclusively by means of the injection-molding process. Alternatively, a barrier sleeve 86 and a barrier film 88 can be arranged on the inside, as is shown in the right part of the figure.

FIG. 11 shows another variant of a connection element 90 with barrier sleeve 92 on the outside and barrier film 94 on the outside in the illustration to the left in the image. On the right-hand side of the image, the connection element 90 is again shown with the barrier sleeve 96 on the inside and the barrier film 98 on the inside.

According to FIG. 12, a connection element 100 has a bulge 102 that is enclosed on the outside by a barrier sleeve 104 together with an outside barrier film 106. Alternatively, the connection element 100 can be used in combination with an inner barrier sleeve 108 and an inner barrier film 110.

FIG. 13 shows a connection element 112 that is embodied as a 45° connection, with a barrier sleeve 120 and a barrier film 116.

FIG. 14 shows a connection element 118 that is embodied as a 90° connection, with a barrier sleeve and a barrier film 122.

As will readily be understood, single- or multilayer barrier sleeves and single- or multilayer barrier films can be used in all of the variants discussed above.

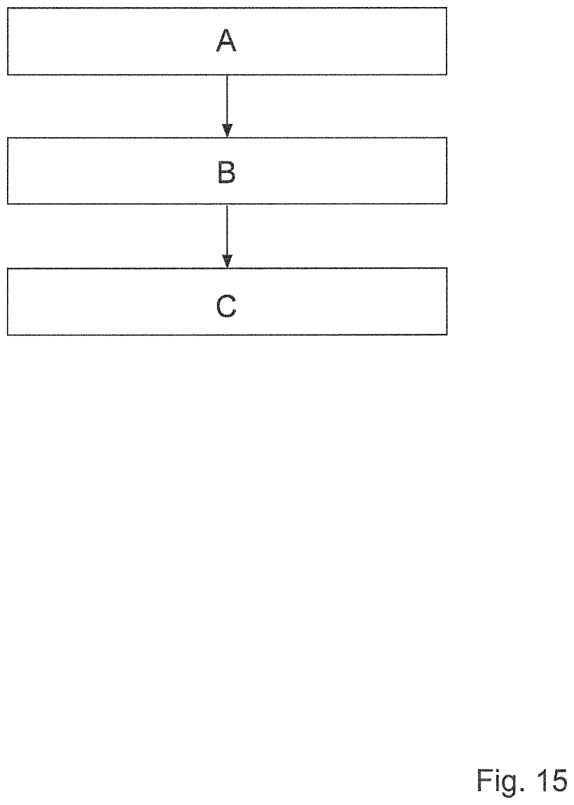

The workflow of an injection-molding method according to the invention is described by way of example with reference to FIG. 15. The following method steps take place in an injection-molding method according to the invention for manufacturing a half-shell of a liquid container for a motor vehicle:

A providing a barrier film in a cavity of an injection-molding tool, the cavity being provided for the purpose of shaping the half-shell;

B providing a barrier sleeve in the cavity;

C injecting plasticized injection-molding material into the cavity,
with plasticized injection-molding material being sprayed onto the barrier film and/or the barrier film being back-injected with plasticized injection-molding material; and
with the barrier sleeve being back-injected with plasticized injection-molding material and/or overmolded with plasticized injection-molding material to form a connection element, in particular a connecting piece, of the half-shell.

### REFERENCE SYMBOLS

1 connection element
2 connection element
3 liquid container
4 liquid container
5 wall
6 half-shell
7 barrier layer
8 half-shell
9 carrier layer
10 storage volume
11 hose
12 fuel
13 permeation path
14 barrier film
16 barrier film
18 hose
20 barrier sleeve
22 permeation path
24 through hole
26 outer surface
28 inner surface
30 through hole
32 barrier layer
34 covering layer
36 barrier layer
38 covering layer
40 injection-molding material, carrier material
41 carrier layer
42 area
44 barrier sleeve
46 barrier film
48 area
50 collar
52 connection element
54 connection element
56 barrier sleeve
58 barrier film
60 side
62 side
64 flange
65 connection element
66 barrier sleeve
68 barrier film
70 flange
72 connection element
74 flange
76 barrier film
80 connection element
82 barrier sleeve
84 barrier film
86 barrier sleeve
88 barrier film
90 connection element
92 barrier sleeve
94 barrier film
96 barrier sleeve
98 barrier film
100 connection element
102 bulge
104 barrier sleeve
106 barrier film
108 barrier sleeve
110 barrier film
112 connection element
114 barrier sleeve
116 barrier film
118 connection element
120 barrier sleeve
122 barrier film
A method step
B method step
C method step
L longitudinal axis
L1 length
U environment
d1 wall thickness
d2 wall thickness

What is claimed is:

1-14. (canceled)

15. A method for manufacturing a half-shell of a liquid container for a motor vehicle, comprising:
providing a barrier film in a cavity of an injection-molding tool;
providing a barrier sleeve in the cavity;
injecting plasticized injection-molding material into the cavity, wherein the plasticized injection-molding material is applied onto the barrier film and/or the barrier film is back-injected with the plasticized injection-molding material;
wherein the barrier sleeve is back-injected with the plasticized injection-molding material and/or overmolded with the plasticized injection-molding material to form a connection element of the half-shell; and
wherein the connection element comprises an adapter.

16. The method as set forth in claim 15, further comprising:
inserting the barrier sleeve into a recess to shape the connection element; and/or
pushing the barrier sleeve onto a mandrel of the injection-molding tool.

17. The method as set forth in claim 15, wherein:
a longitudinal axis of a through hole of the barrier sleeve is oriented transverse to an outer surface or an inner surface of the barrier film; and/or
the barrier film rests against the barrier sleeve.

18. The method as set forth in claim 15, wherein:
a through hole of the barrier film is arranged so as to be flush with a through hole of the barrier sleeve at least in some portion; and/or
a through hole of the barrier film and a through hole of the barrier sleeve are arranged coaxially at least in some portion.

19. The method as set forth in claim 15, wherein:
the barrier sleeve is seated at least partially in a through hole of the barrier film.

20. The method as set forth in claim 15, further comprising:
integrally connecting the barrier sleeve and the barrier film; and/or
integrally connecting the plasticized injection-molding material to the barrier sleeve and/or the barrier film.

21. A liquid container for a motor vehicle, comprising:
two connected half-shells that define a storage volume to hold a liquid;
wherein at least one of the half-shells has a barrier film as a diffusion barrier and has a connection element to connect a hose or pipe; and
wherein at least one barrier sleeve is associated with the connection element that forms a diffusion barrier in a region of the connection element.

22. The liquid container as set forth in claim 21, wherein:
a longitudinal axis of a through hole of the barrier sleeve is oriented transverse to an outer surface or an inner surface of the barrier film.

23. The liquid container as set forth in claim 21, wherein:
a through hole of the barrier film is arranged so as to be flush with a through hole of the barrier sleeve at least in some portion; and/or
a through hole of the barrier film and a through hole of the barrier sleeve are arranged coaxially at least in some portion; and/or
the barrier sleeve is seated at least partially in a through hole of the barrier film.

24. The liquid container as set forth in claim 21, wherein:
the barrier film and/or the barrier sleeve is a monolayer; and/or
the barrier film and/or the barrier sleeve is multilayered; and/or
the barrier film is perforated.

25. The liquid container as set forth in claim 21, wherein:
a through hole of the connection element has a curved shape or has a bend.

26. The liquid container as set forth in claim 25, wherein:
the bend of the connection element is at least a 45° bend.

27. The liquid container as set forth in claim 21, wherein:
the barrier film and the barrier sleeve are arranged so as to overlap at least in some portion; and/or
the barrier film has a flange or funnel shape at least in some portion; and/or
the barrier sleeve has a flange or funnel shape at least in some portion.

28. The liquid container as set forth in claim 21, wherein:
the barrier film and the barrier sleeve are integrally connected to one another; and/or
at least one of the barrier film and the barrier sleeve is connected to an injection-molding material of the half-shell.

29. The liquid container as set forth in claim 21, wherein:
the barrier film has a wall thickness in a range from 100 μm to 1000 μm; and/or
the barrier sleeve has a wall thickness in a range from 100 μm to 1000 μm.
